(19) United States
(12) Patent Application Publication
(10) Pub. No.: US 2021/0055046 A1
(43) Pub. Date: Feb. 25, 2021

(54) Facility For Producing Gaseous Methane By Purifying Biogas From Landfill, Combining Membranes And Cryogenic Distillation For Landfill Biogas Upgrading

(71) Applicant: Waga Energy, Meylan (FR)

(72) Inventor: Guénaël Prince, Saint Egreve (FR)

(21) Appl. No.: 16/949,721

(22) Filed: Nov. 11, 2020

(51) Int. Cl. F25J 3/02; F25J 3/04

(52) U.S. Cl. CPC F25J 3/0209; F25J 3/04169; F25J 2210/66; F25J 2220/66; F25J 2205/60

(57) ABSTRACT

A process and facility for producing gaseous methane by purifying biogas from landfill, can include a VOC purification unit, at least one membrane, a booster, a CO₂ purification unit, a cryodistillation unit comprising a heat exchanger, a distillation column, and a subcooler, a deoxo, and a dryer.

### BACKGROUND

Biogas is produced by the decomposition of organic matter; it is made of methane (CH₄), carbon dioxide (CO₂), and other impurities depending on the biogas source. It can be produced in digesters using inputs from agricultural or Waste Water Treatment Plants (WWTP) operations, or in landfills. Biogas can then be transformed into energy either as a fuel in internal combustion engines coupled with an alternator, thus producing electricity, or the biogas can be upgraded and transformed into Renewable Natural Gas (RNG). This RNG displaces equivalent volumes of fossil natural gas when injected into the Natural Gas (NG) pipelines. This second path of valorization is much more efficient on an energy basis, as it recovers more than 90% of the energy contained in the raw gas, compared to 35% in the case of electricity production (no heat valorization). RNG is more and more seen as an immediate and effective way to decarbonize the use of fossil NG.

### SUMMARY

In accordance with an embodiment a facility for producing gaseous methane by purifying biogas from landfill includes a compression unit for compressing an initial gas flow of the biogas to be purified, a VOC purification unit arranged downstream of the compression unit to receive the compressed initial flow of the biogas and comprising at least one adsorber loaded with adsorbents capable of reversibly adsorbing VOCs to thereby produce a VOC-depleted gas flow; at least one membrane arranged downstream of the VOC purification unit to receive the VOC-depleted gas flow and subject the VOC-depleted gas flow to at least one membrane separation to thereby produce a retentate, a booster arranged downstream of the membrane unit to receive the retentate from the membrane capable of increasing the pressure of the retentate to produce a pressurized retentate, a CO₂ purification unit arranged downstream of the booster to receive the pressurized retentate, wherein the CO₂ purification unit comprises at least one adsorber loaded with adsorbents capable of reversibly adsorbing the majority of remaining CO₂ from the pressurized retentate to produce a CO₂-depleted gas flow; a cryodistillation unit comprising a heat exchanger, a distillation column, and a subcooler, the cryodistillation unit arranged downstream of the CO₂ purification unit to receive the CO₂-depleted gas flow and subject the CO₂-depleted gas flow to a cryogenic separation to separate O₂ and N₂ from the CO₂-depleted gas flow capable and to produce 2 methane enriched flows respectively a low pressure (LP) and a medium pressure (MP) methane enriched flows, a compressor compressing the low pressure methane enriched flow, in order to mix it with the medium pressure methane enriched flow, to produce a medium pressure methane enriched flow, a deoxo arranged downstream the cryodistillation unit to receive the medium pressure methane enriched flow capable of converting the O₂ present in medium pressure methane enriched flow into CO₂ and H₂O to produce an O₂ depleted gas flow, and a dryer, especially a TSA (Temperature Swing Adsorption) arranged downstream the deoxo capable of removing H₂O from the O₂ depleted gas flow

### BRIEF DESCRIPTION OF THE DRAWINGS

FIG. 1 is a graph showing vapor pressure curves of methane, nitrogen, and oxygen;

FIG. 2 is a schematic illustration of a facility in accordance with an embodiment of the disclosure showing a single-column NRU, with methane loop to act as a refrigerant;

FIG. 3 is a schematic illustration of a facility in accordance with an embodiment of the disclosure showing PFD of one arrangement for landfill gas upgrading.

### DETAILED DESCRIPTION

The most important sources of biogas are landfills, but the biogas produced is highly polluted: the CH₄ must be separated from CO₂, hydrogen sulfide (H₂S), volatile organic chemicals (VOCs), siloxanes, and air gases (oxygen and nitrogen) prior pipe injection.

Wagabox® is a breakthrough technology to transform the raw landfill biogas (RBG), into clean RNG: this technology is depicted in the patent FR-B-3046086 (US patent application US2019/0001263). This process and corresponding facility has multiple steps to remove the impurities:
Blowers to apply vacuum and extract biogas from the landfill and to feed compressors
Active carbon (AC) filters for H₂S (or any other available technology) removal
Drier to remove moisture and some soluble impurities
Conventional membrane unit:
   Compression
   PSA (Pressure Swing Adsorption) for VOCs
   Membranes for CO₂: 1, 2 or 3 stages
PTSA (Pressure Temperature Swing Adsorption) for the remaining CO₂ at membrane system outlet
Cryo-distillation for air gases (N₂ & O₂) removal from CH₄
Grid compression, as distillation occurs at low pressure.

It shall be noted that this technology can be applied for other gas which composition would be closed to landfill biogas: for example, coal bed methane and coal mine methane are also gases that contain CO₂, air gases, and other pollutants.

### NRU Technologies

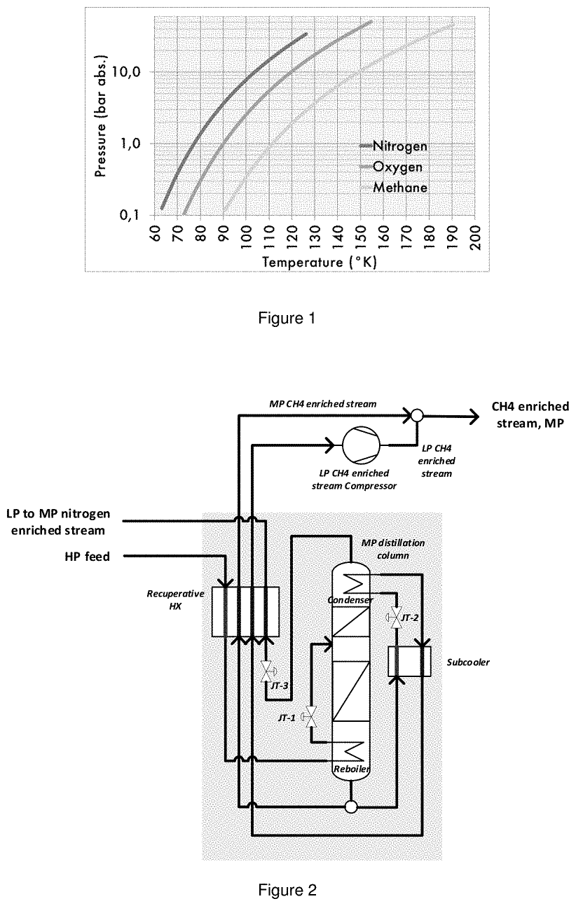

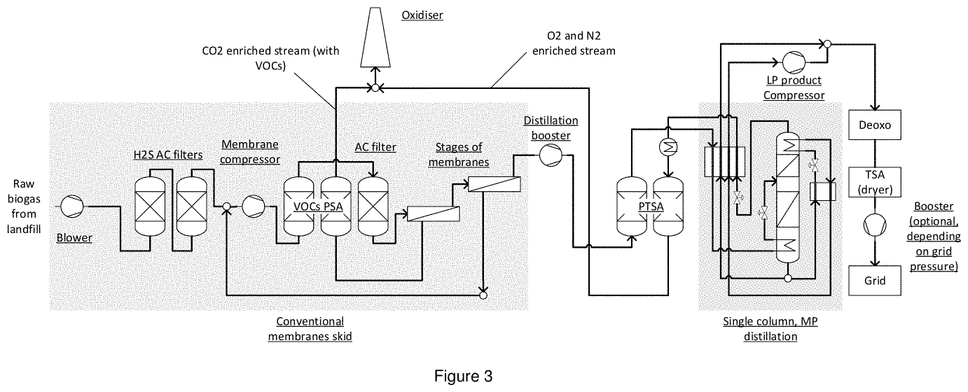

Cryodistillation (meaning distillation at cryogenic temperature) is a well-known process for separating nitrogen and methane. It is widely used in the oil & gas industry in order to separate nitrogen from methane when the gas field is nitrogen-enriched. This process uses equipment commonly named NRU (Nitrogen Removal Units). Cryodistillation is the most efficient separation process as methane and nitrogen demonstrate a great difference of volatility, meaning the separation is easy compared to a “warm” process like adsorption, or gas permeation membranes (see FIG. 1).

The separation of nitrogen and methane by distillation must be performed at low temperature, as distillation requires partially liquefied components. At atmospheric to intermediate pressures (up to 300 psia), methane and nitrogen shall therefore be cooled down to low temperatures to liquefy them.

Multiple process schemes have been developed over the years; we describe hereafter a few of them, that are now considered state-of-the-art technologies:

1. Simple distillation column operated at medium to high pressure (typically 300 to 400 psia), operated by a closed-loop methane heat-pump system that provides both the reboiler and condenser duty. Energy consumption of this process is high.

2. Double column process: this process uses two distillations columns operating at two different pressures, that are thermally linked; the condenser for the high-pressure column provides heat to the reboiler of the low-pressure column. The process provides all the refrigeration for the separation through Joule-Thomson expansion of the fluid in the location chosen for the process. This process has great performances, but the methane recovery rate depends on the nitrogen content; if the nitrogen content drops below 30%, the methane recovery is reduced.

3. Simple distillation column operated at medium pressure (approximately 300 psia approximately), with a portion of the methane used as a refrigerant in the condenser of the distillation column, while the heat for the reboiler is provided by the feed gas prior to the Joule-Thomson discharge and introduction in the distillation column.

However, those NRU process have never been applied to biogas upgrading, because of the presence of oxygen along with methane and nitrogen. Indeed, oxygen boiling temperature is in between nitrogen and methane For example, at 14.7 psia pure nitrogen boils at 77.3K, pure oxygen at 90.2K and pure methane at 111.7K. As a consequence, oxygen will naturally concentrate in the distillation, leading to an enriched-oxygen mixture and a potentially explosive mixture with methane.

This challenge has been overcome by the Applicant, which developed an intrinsically safe process that allows the distillation of the mixture oxygen, nitrogen and methane without any concentration of oxygen, while maintaining very good performances (energy consumption, and methane recovery rate). This process is more detailed in the patent FR-B-3051892. This patented distillation technology, along with the patented combination of a membrane unit and distillation unit for RNG production (patent FR-B-3046086/US patent application US2019/0001263) have paved the way for the Wagabox® to be the highest performing technology when it comes to landfill gas upgrading for moderately (below 2% nitrogen) to highly (above 25% of nitrogen) air-polluted biogas.

The instant invention focuses on how to integrate another NRU distillation technology, downstream from a conventional membrane unit, based on Waga Energy SA patent FR-B-3046086 (US patent application US2019/0001263).

The chosen NRU technology is the single-column, medium pressure, distillation process, as depicted in the details of U.S. Pat. No. 5,375,422, from the company BCCK Engineering, Inc. in Midland, Tex. This technology is of particular interest as it has recently been implemented on a landfill site: the Klickitat PUD in Roosevelt Regional Landfill in Washington (USA). On this site, the chosen process includes, as its main components, a combination of a chemical scrubber for CO2 removal, and an NRU from BCCK Engineering, Inc for nitrogen removal.

Simile-Column NRU, with Methane Loop to Act as a Refrigerant

A typical process flow diagram (PFD) of a single column, medium pressure NRU, is shown on FIG. 2. In this unit there are 3 levels of pressure:
High Pressure (HP): from 300 psia to 650 psia,
Medium Pressure (MP): from 145 psia to 300 psia
Low Pressure (LP): 14.5 psia to 30 psia

The process takes advantage of discharging fluids from a higher pressure-level to a lower pressure-level to cool them down through Joule-Thomson (JT) expansion. The process being cryogenic, this is the cold source production, allowing to run continuously the unit without an external cold source. The hidden energy consumption is the gas compression electricity, as gas compression is energy consuming.

Here is a brief explanation of how the process works: the HP feed is introduced in a recuperative heat exchanger (HX), which purpose is to recover cold from the products coming out of the distillation; the MP product is vaporized and reheated during counter-flow through this heat exchanger, along with the nitrogen enriched stream, and the LP product. As a consequence, the feed gas is cooled down. It is further cooled down in the reboiler, sharing the available heat at the bottom of the distillation to generate the ascending vapor. Feed gas is eventually discharged from HP to MP through the valve JT-1.

In the distillation column, the components are separated due to their difference of volatility at the distillation operating pressure (MP): liquid phase is enriched in methane while going down in the distillation column, while vapor is enriched in nitrogen. Differential temperature is governing the separation: the bottom of the distillation is at a higher temperature than the top. Oxygen splits into the liquid methane phase at the bottom, and vapor nitrogen phase at the top. It is not an object to assess if this separation in this process is safe considering the risk of oxygen enrichment in the distillation column.

A portion of MP liquid methane at the distillation bottom is sent to a sub-cooler, and then discharged at LP in the condenser. This discharge further cools down the liquid methane, that is now cold enough to act as a refrigerant for the condenser.

Two methane-enriched products are recovered at ambient temperature at the outlet of the recuperative HX: 1. the LP product, and 2. the HP product. A LP product compressor can then be installed in order to mix the products together and deliver a single product at MP.

Integration of a Single-Column NRU Process with a Membrane Unit

### Intermediate Compression (Booster) Downstream of the Membrane Unit:

An important first element of the design is the difference between the operating pressure of the membrane (between 110 psi to 230 psi) and the feed pressure requested by the single-column NRU (300 psi to 600 psi). There is the need for a booster downstream of the membrane unit, and upstream the NRU, that will increase the pressure of the product delivered by the membrane (with a low CO₂ content, almost no H₂O, and low impurities content, but enriched in methane and nitrogen).

### CO2 (and Other Impurities) Removed Prior to the Cryogenic Process:

As mentioned earlier, membrane units are mainly used to remove CO₂ from the biogas, along with a portion of O₂. The other impurities (H₂O, ammonia, siloxanes, H₂S and VOCs) are removed upstream in dedicated AC filters and the VOCs are removed using PSA. Membranes unit can easily deliver a product containing less than 0.5% vol of CO₂ (that is 5,000 ppmv), for example down to 2,000 ppmv. But lower levels of CO₂ are too challenging and will result in both high methane losses from the process, and high energy consumption.

One of the well-known benefits of a cryogenic MP distillation is its tolerance to impurities like CO₂:CO₂ solubility is increased while increasing the pressure, and in addition a higher distillation pressure leads to higher operating temperatures, which in turn reduce the risk of freezing CO₂ in the heat exchangers. A common maximum CO₂ content in methane prior to liquefaction is 50 ppmv; MP cryogenic distillation can tolerate up to 200 ppmv without any operating problem (see Gregory L. Hall, BCCK VP Sales, Nitech™ Nitrogen Rejection Technology: Efficiency Without the Complexity Typically Associated with Nitrogen Rejection (Hydrocarbon Processing, July 2005).

Unfortunately, the maximum level of CO₂ allowed in the NRU is far above the minimum level of CO₂ content in the product from the membrane unit. As a consequence, a CO₂ removal unit shall be installed in between the membrane unit and the NRU. It can be a PTSA unit, that will also remove some of the remaining VOCs and water vapor from the membrane unit product, as depicted in patent FR3051892. In a PTSA unit, CO₂ is adsorbed under pressure, while regeneration is achieved at low pressure and high temperature.

Two options are available here when it comes to integrating the PTSA unit and the booster upstream of the MP distillation unit:
Option 1: Membrane unit+booster+PTSA+MP distillation unit. A benefit here is to adsorb CO₂ and other impurities at a higher pressure (300 to 600 psi), which is favorable for adsorption: adsorption capacity of the media increases with partial pressure of CO₂. This configuration would also allow the adsorption of any remaining oil coming from the booster.
Option 2: Membrane unit+PTSA+booster+MP distillation unit

In order to regenerate the PTSA, a clean stream (meaning containing no CO₂, no water and no other impurities) shall be used to heat the media and remove the CO₂ and other impurities adsorbed. This stream can be the vent gas of the MP distillation column, after discharge through a JT valve (JT-3), as regeneration shall occur at a lower pressure than adsorption. Another option is to use a portion of the clean gas at the outlet of the vessel in adsorption in the PTSA, to discharge the pressure and to use it as the elution stream for the vessel in regeneration mode.

### Oxygen Removal, and the Need for a Deoxo and Dryer (TSA Unit):

Distillation is usually a process operated at low pressure, as lowering the operating pressure increases the difference of volatility between the molecules. As a result, the separation is easier. On the other hand, a NRU, whose purpose is to separate methane from nitrogen, can still be operated at MP to HP, as there is a great difference of volatility between methane and nitrogen. When the NRU separates oxygen from methane, operating at MP to HP can be a drawback, and separation can be more difficult, because the difference of volatility between methane and oxygen is lower than that of methane and nitrogen. As a result, the enriched-methane product can still contain oxygen, at a level that is higher than the maximum level allowed by the interconnecting gas grid (gas pipeline) operator.

The gas grid specifications, which specify the quality requirements of the RNG, differ from country to country, and from state to state in the USA. This is particularly true when it comes to oxygen content in the RNG. Depending on the grid owners, oxygen limits can vary from 1% vol (10,000 ppmv) down to 10 ppmv. However, 2,000 ppmv seems to be the most encountered specification.

In case the MP single column distillation unit cannot meet the oxygen pipeline specification, an additional treatment will have to be done on the product. The solution consists of adding a deoxo and a TSA that will remove oxygen from the RNG, downstream of the cold box. In a deoxo, oxygen is converted into CO₂ and H₂O, by a classical combustion with the methane:

CH₄+2.O₂→CO₂+2.H₂O

This reaction is generally made using a catalyst, in order to lower the reaction temperature. Then, the moisture (H₂O) can easily be removed with a TSA (Temperature Swing Adsorption). In the TSA, water is removed on a dedicated adsorbent in a vessel, while the other vessel is regenerated with heat.

Here again, there are different locations in the process where the deoxo unit can be integrated:
Option 1: the deoxo can be installed downstream of the membrane unit, but upstream of the PTSA unit. In this case, the CO₂ and water produced by the combustion can be removed in the PTSA upstream of the cold box. This configuration has the advantage to save on TSA equipment. But the flow treated is more important as it contains the vent gas of the distillation (and not only the RNG), and the deoxo may have to process gas containing impurities at the membrane outlet.
Option 2: the deoxo can be installed at MP, downstream of the LP methane-enriched product, in order to treat both the MP and LP product. In this case, a TSA will have to be installed in order to remove the water generated by the combustion reaction.

Landfill gas upgrading is not simple, due to the presence of multiple impurities to remove in the raw biogas: CO₂, air gases (nitrogen and oxygen), water, VOCs, H2S, siloxanes.

The applicant has introduced a breakthrough technology that simplifies the landfill gas upgrading process into RNG. This patented technology (patent FR3046086, US patent application US2019/0001263) combines the benefit of the best process for CO₂ removal on one hand (multiple stages of gas permeation membranes), with the best process for nitrogen & oxygen removal on the other hand (cryogenic distillation).

The instant invention highlights the potential of combining those two technologies for landfill gas upgrading, by reviewing another process of cryogenic distillation. The choice between the cryogenic distillation (LP column versus single MP column) becomes a decision of economics (CAPEX and OPEX). Additionally, and most importantly, the choice should take into account the ease of operation and the up-time of the unit. The more equipment there is in a process, the lower total up-time of the unit; and as a consequence, the lower the annual incomes.

Eventually, the choice shall take into account the experience of the technology in the field of landfill gas upgrading—with more than 10 units up and running, the Wagabox® is the most referenced process featuring the successful combination of membranes and cryodistillation.

In accordance with an embodiment a facility for producing gaseous methane by purifying biogas from landfill includes a compression unit for compressing an initial gas flow of the biogas to be purified, a VOC purification unit arranged downstream of the compression unit to receive the compressed initial flow of the biogas and comprising at least one adsorber loaded with adsorbents capable of reversibly adsorbing VOCs to thereby produce a VOC-depleted gas flow; at least one membrane arranged downstream of the VOC purification unit to receive the VOC-depleted gas flow and subject the VOC-depleted gas flow to at least one membrane separation to thereby produce a retentate, a booster arranged downstream of the membrane unit to receive the retentate from the membrane capable of increasing the pressure of the retentate to produce a pressurized retentate, a CO₂ purification unit arranged downstream of the booster to receive the pressurized retentate, wherein the CO₂ purification unit comprises at least one adsorber loaded with adsorbents capable of reversibly adsorbing the majority of remaining CO₂ from the pressurized retentate to produce a CO₂-depleted gas flow; a cryodistillation unit comprising a heat exchanger, a distillation column, and a subcooler, the cryodistillation unit arranged downstream of the CO₂ purification unit to receive the CO₂-depleted gas flow and subject the CO₂-depleted gas flow to a cryogenic separation to separate O₂ and N₂ from the CO₂-depleted gas flow capable and to produce 2 methane enriched flows respectively a low pressure (LP) and a medium pressure (MP) methane enriched flows, a compressor compressing the low pressure methane enriched flow, in order to mix it with the medium pressure methane enriched flow, to produce a medium pressure methane enriched flow, a deoxo arranged downstream the cryodistillation unit to receive the medium pressure methane enriched flow capable of converting the O₂ present in medium pressure methane enriched flow into CO₂ and H₂O to produce an O₂ depleted gas flow, and a dryer, especially a TSA (Temperature Swing Adsorption) arranged downstream the deoxo capable of removing H₂O from the O₂ depleted gas flow.

What is claimed:

1. A facility for producing gaseous methane by purifying biogas from landfill, comprising:
a compression unit for compressing an initial gas flow of the biogas to be purified,
a VOC purification unit arranged downstream of the compression unit to receive the compressed initial flow of the biogas and comprising at least one adsorber loaded with adsorbents capable of reversibly adsorbing VOCs to thereby produce a VOC-depleted gas flow;
at least one membrane arranged downstream of the VOC purification unit to receive the VOC-depleted gas flow and subject the VOC-depleted gas flow to at least one membrane separation to thereby produce a retentate;
a booster arranged downstream of the membrane unit to receive the retentate from the membrane capable of increasing the pressure of the retentate to produce a pressurized retentate;
a CO₂ purification unit arranged downstream of the booster to receive the pressurized retentate, wherein the CO₂ purification unit comprises at least one adsorber loaded with adsorbents capable of reversibly adsorbing the majority of remaining CO₂ from the pressurized retentate to produce a CO₂-depleted gas flow;
a cryodistillation unit comprising a heat exchanger, a distillation column, and a subcooler, the cryodistillation unit arranged downstream of the CO₂ purification unit to receive the CO₂-depleted gas flow and subject the CO₂-depleted gas flow to a cryogenic separation to separate O₂ and N₂ from the CO₂-depleted gas flow capable and to produce 2 methane enriched flows respectively a low pressure (LP) and a medium pressure (MP) methane enriched flows;
a compressor compressing the low pressure methane enriched flow, in order to mix it with the medium pressure methane enriched flow, to produce a medium pressure methane enriched flow;
a deoxo arranged downstream the cryodistillation unit to receive the medium pressure methane enriched flow capable of converting the O₂ present in medium pressure methane enriched flow into CO₂ and H₂O to produce an O₂ depleted gas flow; and
a dryer, especially a TSA (Temperature Swing Adsorption) arranged downstream the deoxo capable of removing H₂O from the O₂ depleted gas flow.
